(19) United States
(12) Patent Application Publication
(10) Pub. No.: US 2009/0267729 A1
(43) Pub. Date: Oct. 29, 2009

(54) Anti-counterfeiting system

(76) Inventors: Harry Rowe, Indianapolis, IN (US); Timothy Carr, Crawfordsville, IN (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/386,558

(22) Filed: Apr. 20, 2009

Related U.S. Application Data
(60) Provisional application No. 61/125,519, filed on Apr. 25, 2008.

(51) Int. Cl. G08B 29/00

(52) U.S. Cl. 340/5.8

(57) ABSTRACT

A method and apparatus for verifying the authenticity of, and detecting tampering with, an item is disclosed. An RFID transponder comprises an antenna resonant circuit which is coupled to an associated integrated circuit when the integrated circuit is positioned proximately to the antenna resonant circuit, thereby enabling the integrated circuit to receive and respond to a radiofrequency query signal. The antenna resonant circuit can be integrated with a capsule or other form of removable packaging, such that it is destroyed upon removal of, or tampering with, the packaging.

### CROSS-REFERENCE TO RELATED APPLICATION

This application claims priority of U.S. Provisional Application Ser. No. 61/125,519, filed Apr. 25, 2008, the disclosure of which is incorporated herein by reference.

### TECHNICAL FIELD

The present invention relates generally to the prevention or detection of product counterfeiting or tampering, and more particularly, to an RFID tag that can be applied to an object to indicate tampering with, or counterfeiting of, the object.

### BACKGROUND OF THE INVENTION

Many expensive products are subject to tampering or counterfeiting in the marketplace. Wines and high-end spirits are particularly susceptible to such activities, as the goods often have high value, and such tampering or counterfeiting may be difficult to detect. Tampering and counterfeiting can become a significant commercial issue, resulting in loss of revenue, reduced consumer confidence in product quality and authenticity, as well as impairment to brand value. Due to their high cost and reliance on consumer goodwill, wine and spirit products are also particularly sensitive to negative market effects that may be caused by product tampering and counterfeiting.

### SUMMARY OF THE INVENTION

In accordance with one embodiment of the invention, a system is provided for verifying the authenticity of an item. The system can be used in connection with an interrogator, which transmits a query in the form of a radio signal, and includes a tamper-resistant transponder, or “tag,” which is attached to the item and responds to the query with a verification signal. The transponder can evidence tampering by virtue of its construction. The transponder includes two components: an antenna circuit, and an associated transponder integrated circuit such as an RFID integrated circuit (“RFID IC”). The antenna circuit and RFID IC are coupled to one another through electro-magnetic coupling rather than by direct connection. The electromagnetic coupling is achieved through close physical proximity between the two components. The two components can be incorporated into different parts of the item, such that they are in close proximity when the item is sealed, but are separated on opening, preferably with one or both being destroyed by the opening process. Destruction of either component of the transponder, or simply separating the two components, can result in disabling of the transponder.

The antenna circuit is designed to resonate in response to a radio frequency signal from an interrogator, such that it can reproduce the radio frequency signal. The antenna circuit includes a coupling element, either inductive or capacitive, which is designed to be brought in close proximity to the transponder integrated circuit. The transponder integrated circuit has an integral resonant circuit designed to couple to the antenna circuit when they are in close proximity.

The integrated circuit generates a verification signal in response to signal passed through the antenna circuit from the interrogator. The verification signal can convey a security code, which is stored in digital memory within the RFID integrated circuit. The security code may optionally be uniquely associated with the item. The authenticity of the item can be verified via analysis of the security code.

When used in the context of packaging for a wine, a wine closure, such as natural or synthetic cork, can be employed, having the integrated circuit affixed to one end. The intermediate antenna resonant circuit can then be affixed to a closure cover, which is placed over the wine closure, such that the antenna resonant circuit is positioned proximate the RFID integrated circuit.

The integrated circuit digital memory can further contain product information, which can be conveyed via the verification signal. The verification signal can then be received and decoded by an RFID interrogator, such as a cellular telephone or handheld device. Information conveyed within the verification signal can be decoded and displayed to a user of the RFID interrogator.

In some embodiments, the security code corresponding to an item can be separately stored in a database. The database may be provided with a communications link to the RFID interrogator. The database can be queried to further verify the authenticity of the item through verification of the security code. In some embodiments, the database can be implemented within the RFID interrogator. The database can be periodically updated with new information through communications with a secondary remote database.

In some embodiments, the security code can be stored within the integrated circuit digital memory in an encrypted format. An encryption key can then be provided in the query signal. Upon receiving the query signal, the integrated circuit verifies whether the provided encryption key operates to decrypt the stored security code. The verification signal can be generated if, and only if, the encryption key operates to properly decrypt the security code.

Other features and advantages of the present invention will become readily apparent from the following detailed description, the accompanying drawings, and the appended claims.

### BRIEF DESCRIPTION OF THE DRAWINGS

FIG. 1 is a partial perspective view of a prior art bottle and closure;

FIG. 2 is a partial perspective view of a prior art bottle and closure, having a protective capsule enclosing the closure;

FIG. 3 is an exploded, partial cutaway diagrammatic view of a stopper and capsule in accordance with an embodiment of the invention;

FIG. 4 is an inverted partial cutaway diagrammatic view of the capsule;

FIG. 5 is a diagrammatic view of the capsule surrounding a bottle neck and closure;

FIG. 6 is a schematic block diagram of a system for verifying the authenticity of an item;

FIG. 7 is a flow chart illustrating a method for programming an RFID IC;

FIG. 8 is a flow chart illustrating one embodiment of a method for verifying the authenticity of an item;

FIG. 9 is a flow chart illustrating a second embodiment of a method for verifying the authenticity of an item;

FIG. 10 is a diagrammatic view of a capsule and bottle closure, in accordance with another embodiment;

FIG. 11 is a perspective view of a bottle closure, in accordance with another embodiment; and

FIG. 12 is a partial cutaway diagrammatic view of a bottle, bottle closure and capsule, in accordance with another embodiment.

### DETAILED DESCRIPTION

While the present invention is susceptible of embodiment in various forms, there are shown in the drawings and will hereinafter be described one or more presently preferred embodiments. of the invention, with the understanding that the present disclosure is to be considered as an exemplification of the invention, and is not intended to limit the invention to the specific embodiments illustrated.

Radiofrequency identification (“RFID”) tags are becoming increasingly popular as tag manufacturing costs are reduced and the technology for implementing RFID systems becomes more widespread and economical. RFID tags typically include a resonant circuit which resonates in response to exposure to a compatible electromagnetic signal. The signal from the resonant circuit can be conveyed to an integrated circuit via direct connection or electro-magnetically, through inductive or capacitive coupling. Upon detection of the conveyed signal, the integrated circuit responds by transmitting a responsive electromagnetic signal, which may contain encoded information. The encoded information can reflect information corresponding to the item to which the RFID tag is attached, a unique security code, or other information.

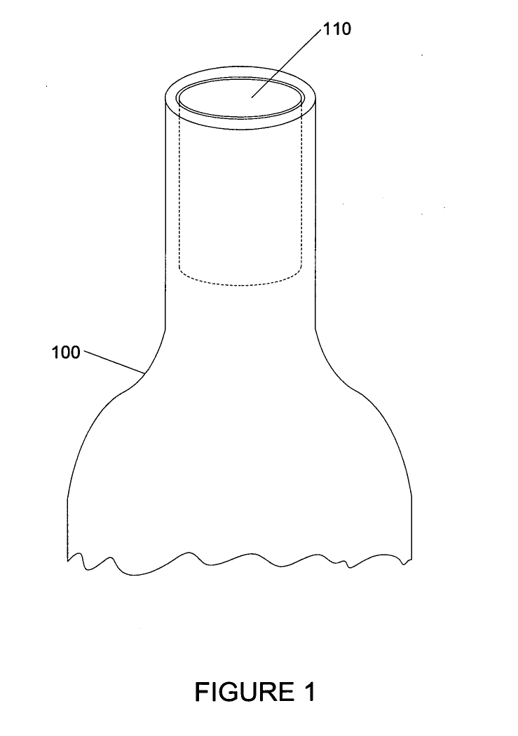

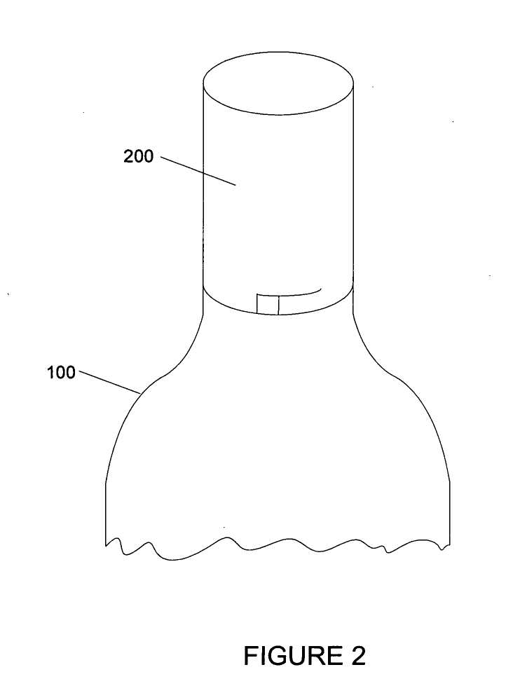

In accordance with one aspect of the invention, an RFID device can be beneficially employed for inhibiting counterfeiting of and/or tampering with, a product. One example of such an application is in the context of wine bottles. FIG. 1 illustrates a conventional wine bottle closure, in which stopper 110 is inserted into a neck portion of bottle 100. Stopper 110 has been traditionally made of cork, although non-cork substitute materials are becoming increasingly commonplace. In such conventional wine bottle packaging, the neck portion of bottle 100 is then covered with capsule 200, as illustrated in FIG. 2. Historically, capsule 200 has often been fabricated from lead foil. More recently, aluminum foil or sheet or polymer materials have been employed. In any event, capsule 200 operates to ensure that stopper 110 remains secured inside the neck of bottle 100 and provides additional protection for the closure.

In some circumstances, it may be difficult to detect or prevent tampering with wine, spirits or other materials that are packaged in bottles that are sealed with closures such as the closure of FIGS. 1 and 2. Capsule 200 and stopper 110 can be removed to exchange, dilute or otherwise tamper with the contents of bottle 100. Stopper 110 can then be reinserted into the neck portion of bottle 100, or replaced with a counterfeit stopper. Counterfeit stoppers can be readily fabricated to resemble the original stopper. Alternatively, even if the counterfeit stopper differs in appearance, many consumers may not be aware of the differences in appearance, and in any event, the stopper often will not be viewed until well after bottle 100 is purchased. Once a stopper is reinserted, a counterfeit replacement capsule can be applied. Since stoppers and capsules are often fabricated from common, readily-available materials, the burden of producing counterfeit stoppers and/or capsules may be relatively low.

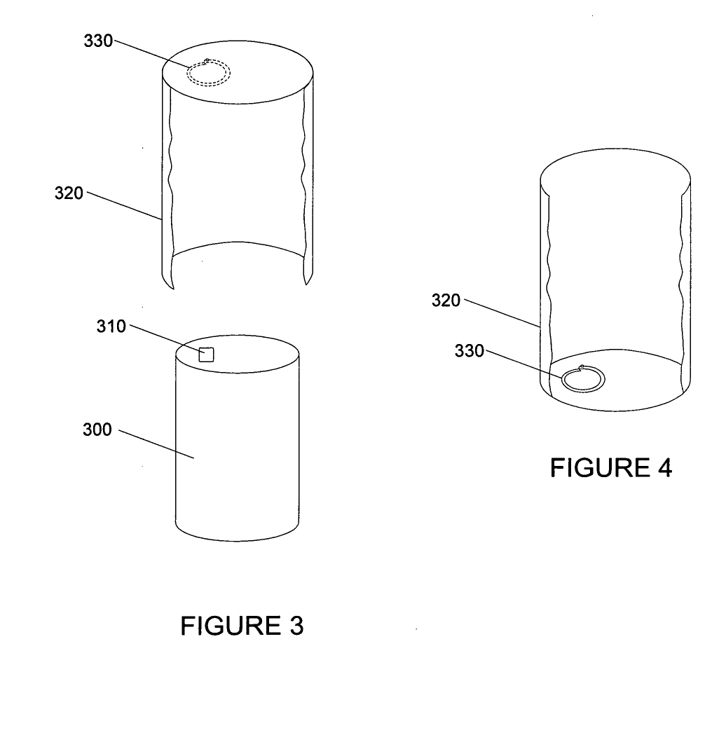

FIG. 3 is an exploded view of an embodiment in which an RFID device is implemented through interaction of stopper 300 and its surrounding capsule 320 (illustrated in partial cutaway view). In particular, stopper 300 includes RFID integrated circuit (“RFID IC”) 310 mounted on its top end. In the illustrated embodiment, RFID IC 310 is a passive RFID device, which responds to a coded electromagnetic signal by emitting a responsive electromagnetic signal. While RFID IC 310 is described herein as an “integrated circuit”, it is understood that in some embodiments, the structure referred to as RFID IC 310 may include additional components such as resistive or capacitive structures, or discrete resonant structures, although such additional components will preferably be implemented with an integrated circuit on a common substrate.

Passive RFID ICs can be associated with a resonant structure which increases the efficiency with which electromagnetic signals are received. In some instances, such resonant structures are directly connected to the RFID IC to conduct the received electromagnetic energy to the RFID IC. Alternatively, a resonant structure can be coupled to the RFID IC indirectly. In this case, the electromagnetic signal received from the interrogator induces a current in the intermediate, antenna resonant structure. This current passes through a portion of the structure which is coupled wirelessly, either inductively or capacitively, to another resonant structure integrated within or connected to the RFID IC, thereby inducing a current in that secondary, integrated resonant structure. Embodiments of such devices, having intermediate antenna resonant structures, are described in U.S. Pat. No. 7,119,693, the contents of which are incorporated herein by reference.

In the embodiment of FIG. 3, RFID IC 310 is capable of interaction with a resonant structure implemented on or within capsule 320. Resonant structure 330 is implemented on the underside of the top surface of capsule 320, as further illustrated in the inverted partial cutaway view of capsule 320 provided by FIG. 4. While resonant structure 330 is attached to the underside of capsule 320 in FIGS. 3 and 4, it is understood that other placements of resonant structure 330 can also be used. For example, in embodiments in which capsule 320 is formed from a multi-layer sheet media substrate, resonant structure 330 can be embedded between two or more layers of material from which the capsule is formed.

Various structures can be used to implement resonant structure 330. In some embodiments, resonant structure 330 can be formed through deposition of conductive ink onto capsule 320. In other embodiments, resonant structure 330 can be pre-formed from conductive material, such as copper or aluminum, deposited on a non-conductive substrate, and formed into a resonant structure via a chemical or physical etching process.

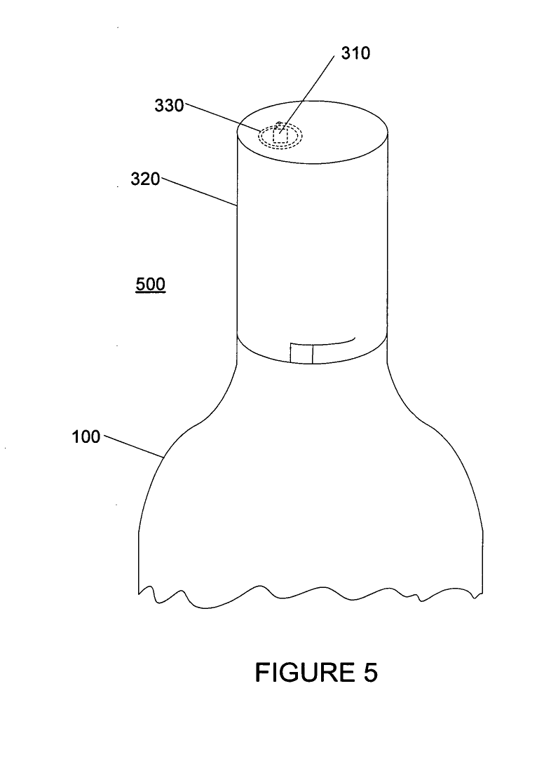

FIG. 5 depicts apparatus 500, which includes capsule 320 mounted over the neck of bottle 100, such that it covers stopper 300. A variety of techniques can be employed to achieve mounting of capsule 320 onto bottle 100. The capsule application technique may depend upon the composition of the capsule. For example, in accordance with one embodiment, capsule 320 can be formed from a sheet-stock polymer material which contracts around the neck of bottle 100 upon application of heat, sometimes referred to as a shrink-wrap process.

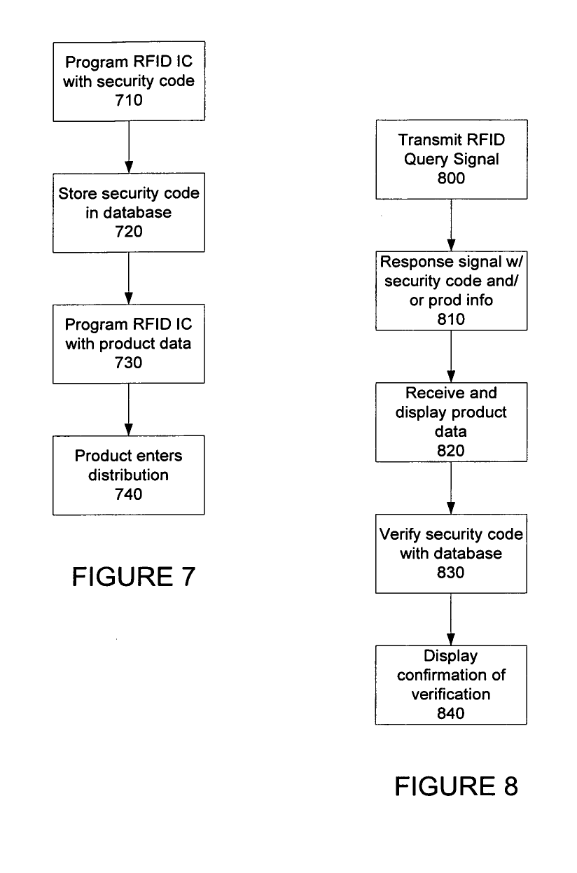

When capsule 320 is positioned over the neck of bottle 100, RFID IC 310 is physically situated near resonant structure 330, such that RFID IC 310 and resonant structure 330 are electromagnetically coupled. In accordance with one possible application of apparatus 500, RFID IC 310 can then be programmed via the operation illustrated in FIG. 7. In step 710, RFID IC 310 is first programmed with a security code. In the illustrated method, the security code uniquely corresponds to apparatus 500, and is stored on digital memory within RFID IC 310. A coded electromagnetic signal is coupled to resonant structure 330, which, in turn, resonates to emit a secondary signal. The secondary signal is received by RFID IC 310 through coupling to an integral resonant circuit within RFID IC 310, and decoded. RFID IC 310 then stores the security code data within integrated non-volatile digital memory.

In step 720, the security code is stored separately in a database, which is preferably maintained by a third party, such as the manufacturer of apparatus 500 or an independent authentication service provider. The security code can be correlated within the database to product information corresponding to apparatus 500. In the case of a wine bottle, the product information may include the type of wine, its vintage, vintner name, historical information concerning the vineyard from which the wine was produced, information concerning the bottler, tasting notes, ratings, suggested foods to pair with the wine, and other information. In some applications, the database can also be periodically populated with additional information describing each sale of the product corresponding to the security code, thus providing a record of chain of title for the product. The product information stored in the database can later be recalled from the database by referencing the product security code. Accordingly, the product information recalled from the database can be subsequently compared against apparatus 500 itself to confirm the authenticity of the product.

Finally, in step 730, RFID IC 310 is optionally programmed with some or all of the product information data directly, which is stored in digital non-volatile memory within RFID IC 310. By storing the product information data directly within RFID IC 310, apparatus 500 can be interrogated locally by an RFID-enabled device to recall the product information without requiring communication connectivity with the database. Once RFID IC 310 has been programmed, the product is sold and/or distributed (step 740).

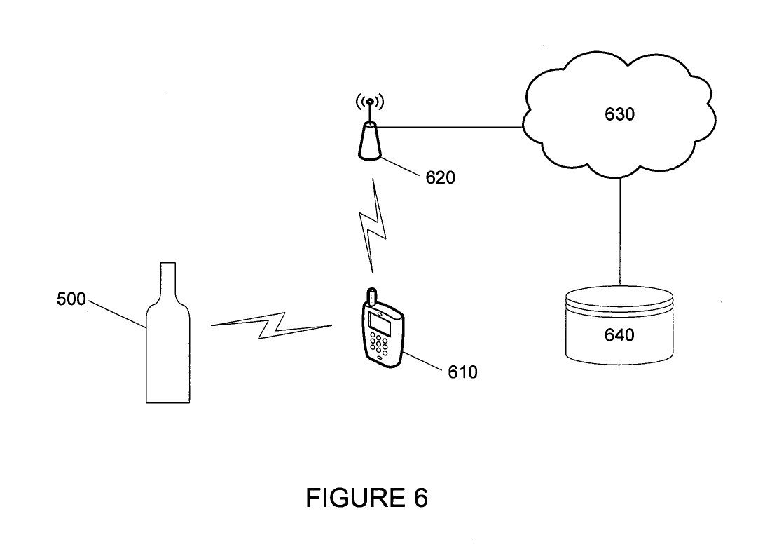

In use, the information stored within RFID IC 310 can be used to verify the authenticity of apparatus 500, and/or to provide additional information, such as information which may be useful to consumers at, e.g., the point of purchase. For example, FIG. 6 depicts and environment in which the present system can be utilized. FIG. 8 illustrates an embodiment of a method through which the system of FIG. 6 can be utilized. Specifically, in step 800, an RFID query signal is transmitted from RFID interrogator 610 to apparatus 500. The RFID query signal has characteristics, such as amplitude and frequency, which are tuned to cause a response in resonant structure 330 within apparatus 500.

It is contemplated that RFID interrogator 610 could be implemented using a variety of devices. For example, in some embodiments, RFID interrogator 610 may be a cellular telephone having an RFID near field communication feature. In other embodiments, RFID interrogator 610 could be an application-specific hardware device provided by a retailer near the point of purchase. In any event, the RFID query signal causes resonant structure 330 to respond by emitting a secondary signal, which induces a response in a secondary resonant structure integral within RFID IC 310.

In step 810, apparatus 500 responds by emitting a response signal. The response signal may be encoded with the security code, and optionally, product information. In step 820, the response signal is received by RFID interrogator 610 and decoded. Product information can be presented to a customer or other user of RFID interrogator 610 via an electronic display provided thereby. Thus, the product information can be used to assist a potential customer in a decision as to whether to purchase a product. Additionally, the product information can provide an additional level of authenticity verification, as the user can verify whether the product information programmed into the RFID IC corresponds to the actual product to which the RFID IC has been attached.

Once the security code has been received by RFID interrogator 610, it can be used to further verify the authenticity of apparatus 500 (step 830). For example, RFID interrogator 610 can transmit a query to database 640 via wireless data network 620 and Internet 630. Database 640 responds by returning verification information to RFID interrogator 610, via Internet 630 and wireless data network 620. The verification information can include an indication as to whether the security code is valid. The verification information may also include a description of the product to which the security code was originally assigned, so that the recipient can compare the product description to the actual product from which the security code was queried. Database 640 may also provide product information corresponding to the product with which the security code was originally associated. The product information provided by database 640 can be used in lieu of storing product information within RFID IC 310, or it may supplement product information that is stored within RFID IC 310.

Finally, in step 840, RFID interrogator 610 displays information indicative of the authenticity of, and/or otherwise descriptive of, apparatus 500. For example, RFID interrogator 610 can display an indication as to whether the detected security code is valid within database 640. RFID interrogator 610 may also display a description of the product with which the security code was originally associated, to facilitate a determination as to whether the product has been substituted, altered or tampered with.

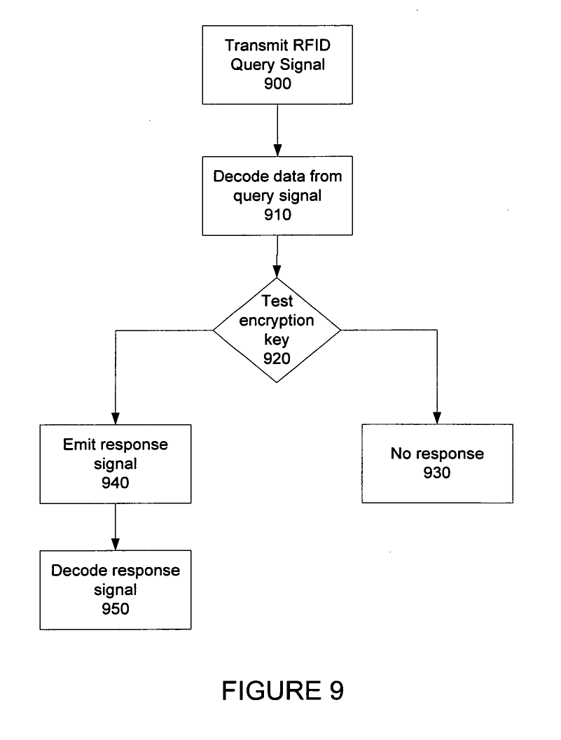

In accordance with another embodiment, in some applications it may be desirable to limit access to information stored within the tag to authorized individuals, thus further inhibiting unauthorized duplication of the product. FIG. 9 illustrates one embodiment of such an operation. In the embodiment of FIG. 9, implemented via the apparatus of FIG. 6, the security code stored within RFID IC 310 is encrypted data prior to distribution of apparatus 500, to which RFID IC 310 is attached. In step 900, a query signal is transmitted from RFID interrogator 610 to apparatus 500.

In step 910, RFID IC 310 decodes data conveyed by the query signal, towards extracting an encryption key. The encryption key is tested in step 920, such as through application of the key to the encrypted security code. If the query signal does not contain the correct encryption key, then RFID IC 310 provides no further response, 930. If the query signal does convey the correct encryption key, then RFID IC 310 emits a response signal, step 940. The response signal may contain the decrypted security code, product information, or other data stored within RFID IC 310. In step 950, the response signal is received by RFID interrogator 610, decoded, and displayed.

By limiting the transmission of data from RFID IC 310 to queries from authorized users, prospective counterfeiters are further inhibited from recovering data from RFID IC 310 and applying it to a counterfeit product.

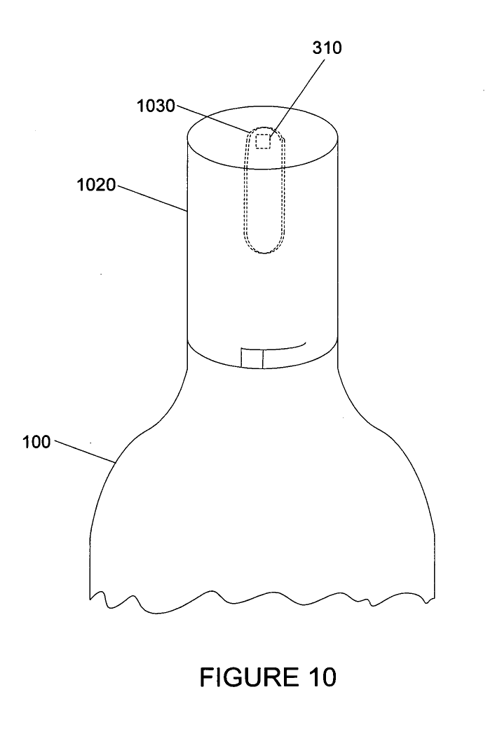

While FIGS. 3-5 illustrate one embodiment of intermediate and integral resonant structures positioned at the end of a cork or stopper-type closure, is understood that other configurations can be readily employed for different applications. The size, shape and orientation of the resonant structures can vary depending upon required closure or package type, electromagnetic signal frequency, interrogator technology, or other design criteria. For example, FIG. 10 illustrates another embodiment, still in the context of a wine bottle application, in which an enlarged resonant structure 1030 is provided on or within capsule 1020. Resonant structure 1030 spans multiple surfaces of capsule 1020, potentially providing enhanced coupling of signal energy to RFID IC 310 in certain circumstances.

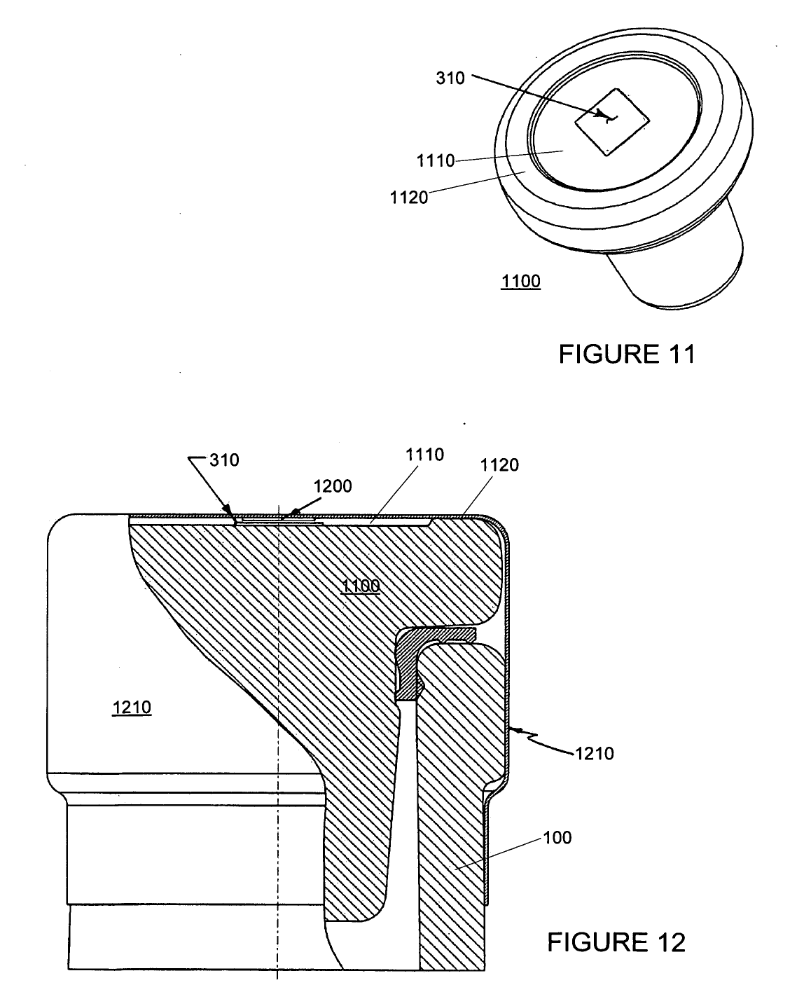

FIGS. 11 and 12 illustrate a further embodiment, having an alternative bottle closure 1100. Bottle closure 1100 includes RFID IC 310, positioned within recessed area 1110 on the top surface of closure 1100. Recessed area 1110 is surrounded by shoulder portion 1120, which can act to protect RFID IC 310 from impact or damage. FIG. 12 illustrates bottle closure 1100, inserted into the open neck of bottle 100. Closure 1100 and bottle neck 100 are covered with polylaminate capsule 1210. Resonant circuit 1200 is attached to the underside of polylaminate capsule 1210, proximate to RFID IC 310, to enable capacitive or inductive coupling between RFID IC 310 and resonant circuit 1200.

In addition to security and authenticity verification enabled through communications with data stored on RFID IC and elsewhere, tampering and/or counterfeiting is further discouraged in the embodiments of FIGS. 3-12 by the implementation of an antenna resonant circuit in the capsule to enable wireless communications with the RFID IC. After their initial application to a container closure, capsules such as capsules 320, 1020 and 1210 are frangible such that they are typically cut, torn, stretched or otherwise damaged during the process of their removal. Preferably, the antenna structure is formed in a manner that promotes its destruction upon removal of the capsule. For example, the antenna structure may be formed through application of a conductive ink that provides little or no structure integrity upon deformation or cutting of the capsule material to which it is applied. The antenna structure can also be applied over a seam, tear tab, perforation or other line of weakening formed in the capsule material, such that the antenna structure is more likely to be severed during removal of the capsule.

If the original capsule is subsequently reapplied, tampering will be evident due to the damage incurred during the prior removal of that capsule. If the removed capsule is replaced with a new capsule of conventional construction, lacking a properly-configured antenna resonant circuit, wireless communications with the associated RFID IC will be prevented. This disabling of RFID functionality can likewise reveal the occurrence of tampering. A supply of closure capsules having a properly-matched and correctly-positioned integrated resonant circuit may be unavailable to many prospective counterfeiters.

While certain embodiments are illustrated in the context of packaging for wine or spirits, it is to be understood that aspects of the invention described herein are readily applicable to other types of items and/or packaging for items. For example, an antenna resonant structure can be readily applied to plastic shrink wrap or other types of packaging that must be removed before accessing the item to which the shrink wrap or other packaging is applied. Moreover, other aspects described herein, such as the authenticity verification and remote database functionality, can be readily applied in a variety of contexts, regardless of whether the RFID transponder is implemented using the two-part construction described herein. From the foregoing, it will be observed that numerous other modifications and variations can be affected without departing from the true spirit and scope of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A system for verifying the authenticity of an item, comprising:
an antenna resonant circuit configured to resonate in response to a radio frequency query signal, to produce an induced current;
an integrated circuit associated with the item, having an integral resonant circuit coupled to the antenna resonant circuit such that a current in the antenna resonant circuit induces a signal in the integral resonant circuit when the integral resonant circuit is positioned proximate to the antenna resonant circuit;
whereby the signal is not induced in the integral resonant circuit when the integral resonant circuit resides in a position that is not proximate to the antenna resonant circuit;
digital memory within the integrated circuit containing a security code;
a radiofrequency verification signal containing the security code, generated by the integrated circuit in response to the signal induced in the integral resonant circuit;
whereby the authenticity of the item can be verified via analysis of the security code.

2. The system of claim 1, in which the item is a beverage container, the system further comprising:
a container closure having an outer end to which the integrated circuit is affixed; and
a closure cover to which the antenna resonant circuit is affixed.

3. The system of claim 2, in which the integrated circuit digital memory is further configured to store product information descriptive of the item; and
the radiofrequency verification signal comprises a signal conveying the stored product information.

4. The system of claim 1, in which the security code is also stored in a remote database.

5. The system of claim 4, in which the security code is uniquely associated with the item.

6. The system of claim 4, further comprising:
an RFID interrogator configured to generate the radiofrequency query signal, detect the radiofrequency verification signal, and query the remote database to verify the security code received in the radiofrequency verification signal.

7. The system of claim 6, in which the RFID interrogator is a cellular telephone device having a communication link with the remote database.

8. The system of claim 6, in which the RFID interrogator is a handheld device located within a retail store having a communication link with the remote database.

9. The system of claim 6, in which:
the RFID interrogator is a handheld device located within a retail store; and
the remote database is stored within the RFID interrogator.

10. The system of claim 9, in which the remote database is periodically updated based upon information stored in a secondary remote database.

11. The system of claim 1, in which the radiofrequency verification signal is further generated only in response to a signal induced in the integral resonant circuit by a radiofrequency query signal containing predetermined query information.

12. The system of claim 11, in which:
the predetermined query information is an encryption key;
the security code within the digital memory is encrypted; and
the integrated circuit is configured to generate the verification signal if, and only if, the encryption key operates to decrypt the security code.

13. A system for verifying the authenticity of an item, comprising:
an RFID transponder configured to respond to a radio frequency query signal generated by an RFID interrogator;
digital memory within the RFID transponder containing a security code associated with the item;
a radiofrequency verification signal containing the security code, generated by the RFID transponder in response to the radiofrequency query signal;
a database containing previously-stored verification information;
whereby the RFID interrogator is configured to query the database upon receipt of the radiofrequency verification signal to verify the authenticity of the item through comparison of the security code with the previously-stored verification information.

14. The system of claim 13, in which the database is stored within the RFID interrogator.

15. The system of claim 14, further comprising a secondary database, where the RFID interrogator is configured to periodically update information stored within the database based upon information stored in the secondary database.

16. An apparatus for detecting tampering with an item, comprising:
frangible packaging applied to the item and configured for removal prior to use of the item;
an antenna resonant circuit attached to the frangible packaging, which can resonate in response to a radio frequency query signal;
an integrated circuit associated with the item, having an integral resonant circuit coupled to the antenna resonant circuit such that a current in the antenna resonant circuit can induce a signal in the integral resonant circuit when the integral resonant circuit is positioned proximate to the antenna resonant circuit, the integrated circuit further configured to produce a radiofrequency verification signal in response to the signal induced in the integral resonant circuit;
whereby no signal is induced in the integral resonant circuit when the integral resonant circuit resides in a position that is not proximate to the antenna resonant circuit or when the antenna resonant circuit is damaged;
whereby failure to produce a radiofrequency verification signal in response to a radiofrequency query signal is indicative of tampering.

17. The apparatus of claim 16, in which the antenna resonant circuit overlaps a line of weakening formed in the frangible packaging.

18. The apparatus of claim 17, in which the line of weakening comprises a tear tab.

19. The apparatus of claim 17, in which the line of weakening comprises a seam.

20. The apparatus of claim 17, in which the line of weakening comprises a perforation.

21. The apparatus of claim 16, in which the antenna resonant circuit comprises conductive ink.

22. The apparatus of claim 21, in which the conductive ink is applied over a line of weakening formed in the frangible packaging.
